(19) United States
(12) Patent Application Publication
(10) Pub. No.: US 2003/0097909 A1
(43) Pub. Date: May 29, 2003

(54) Device for imparting rotary motion to a barrel cap

(76) Inventor: Michael J. Pote, New Lenox, IL (US)

Correspondence Address: CHEPSKOV & FLAYNIK, Suite 1447, 20 NORTH WACKER DR, CHICAGO, IL, 60606, US

(21) Appl. No.: 09/991,144

(22) Filed: Nov. 23, 2001

(51) Int. Cl. B67B 7/18

(52) U.S. Cl. 81/3.4

(57) ABSTRACT

A device 10 for imparting rotary motion to a barrel cap 19 includes a first portion 12 having a substantially square aperture 14 to receive a shank portion of a hand held rotary drive tool, a second portion 16 having an annular recess 18 with radially spaced drive recesses 24 in an inner cylindrical wall 22 that snugly engage cooperating protuberances 25 on an outer cylindrical wall 42 of the barrel cap 19, and a set screw aperture 20 that removably receives a set screw to secure the device 10 to the rotary drive tool.

### BACKGROUND OF THE INVENTION

1. Field of the Invention

The present invention relates to rotary drive tools and more particularly, to a device that imparts rotary motion to a barrel cap.

2. Background of the Prior Art

Fifty-five gallon drums are very common and great quantities are used for industrial purposes. Generally, the drums have one end open that is ultimately sealed by a cover with a diameter equal to the inner cylindrical wall of the barrel, or the drums are completely enclosed except for a relatively small, threaded orifice in one end of the barrel. The treaded orifice removably receives a barrel cap that may be fabricated from metal or plastic depending upon the contents therein. Further, the configuration of the barrel caps vary and will include recesses and/or protuberances that snugly engage a rotary drive tool that forcibly rotate the barrel cap to tightly secure the cap to or remove the cap from the barrel.

The problems with prior art rotary drive tools for barrel caps are that the tool is specially designed, expensive, relatively large and heavy, and require an inordinate amount of time to operate. More specifically, an operator must radially turn the drive tool while holding the drive tool adjacent to the barrel cap until cooperating recesses and protuberances of the drive tool and barrel cap snugly engage, then the operator forcibly rotates the tool until the barrel cap is tightened to or removed from the barrel. Examples of prior art rotary drive tools that include ratchet and drive sockets are depicted in a McMaster-Carr catalog in section “Drum-Plug & Structural Wrenches” on page 2485.

A need exists for a device that transfers rotary motion from a standard, hand-held power tool or ratchet via a shank portion extending therefrom, to a barrel cap having a preselected configuration. The device needs to be relatively small, light weight, capable of being held in an operator's hand, and capable of being removably secured to the shank portion of the hand-held rotary drive tool. Further, the device needs to engage a barrel cap quickly with minimal device rotation to cause the respective recesses and protuberances of the device and cap to snugly engage to impart rotary motion from the device to the cap, and must forcibly rotate the cap without “wobble” or damage to the cap.

### SUMMARY OF THE INVENTION

It is an object of the present invention to overcome many of the disadvantages associated with devices that impart rotary motion to barrel caps.

A principle object of the present invention is to provide a device that imparts rotary motion to a barrel cap. A feature of the device is a relatively small first portion having a centered aperture therethrough that snugly receives a correspondingly configured shank of a rotary drive tool. An advantage of the device is that a standard hand held power tool can be utilized to forcibly rotate the device.

Another object of the present invention is to provide a relatively small device for imparting rotary motion to a barrel cap. A feature of the device is a second portion integrally joined to the first portion, the second portion having a recess configured to snugly receive the barrel cap. An advantage of the device is that an operator can easily hold a rotary drive tool in one hand, the device in the other hand and can quickly connect the two together.

Yet another object of the present invention is to provide a device that is detachably secured to a hand held power tool. A feature of the device is a set screw aperture that removably receives a set screw therein. An advantage of the device is that the operator can hold the rotary drive tool and the device secured thereto in a vertical position with one hand while the device is vertically lowered to receive the barrel cap in the recess of the second portion.

Still another object of the present invention is to provide a device that is capable of forcibly rotating a barrel cap without damaging the cap. A feature of the device is a plurality of recesses that snugly receive longitudinally shorter protuberances of the barrel cap. An advantage of the device is that the barrel cap is not deformed while being forcibly rotated to tighten or loosen the cap relative to the barrel.

Another object of the present invention is to provide a device that quickly engages a barrel cap. A feature of the device is a greater number of radially displaced recesses than the number of protuberances of the barrel cap, the recesses numbering at least a factor of two times more than the protuberances. An advantage of the device is that the operator is required to radially rotate the rotary drive tool a relatively small degree of arc to cause the recesses of the device to receive the protuberances of the cap thereby reducing the time required for the operator to loosen or tighten a barrel cap. Another advantage of the device is the reduction in the cost of manpower to loosen or tighten a barrel cap to the corresponding portion of a standard barrel.

Another object of the present invention is to provide a device that promotes stability and reduces “wobble” when transferring rotary motion from a relatively small shank portion of a hand held rotary drive tool to a barrel cap having a cylindrical outer wall with a relatively large diameter. A feature of the device is a first portion having relatively large metal mass extending longitudinally adjacent to the axis of rotation of the device. An advantage of the device is that a second portion of the device can be configured to include a cylindrical outer wall having a relatively large diameter that will cooperatively receive and rotate the barrel cap in a single radial plane perpendicular to the axis of rotation of the device thereby avoiding rotational wobble of the cap relative to the barrel.

Another object of the present invention is to provide a device that may be fabricated into one of a plurality of possible configurations that can engage and forcibly rotate any preselected barrel cap configuration. A feature of the device is a selectable second portion configuration that includes either recesses or protuberances that snugly engage respective protuberances or recesses of a cooperating barrel cap. An advantage of the device is that one rotary hand tool is capable of forcibly rotating any of a plurality of devices having varying configurations that correspond to the configurations of barrel caps that will be tightened to or removed from barrels.

Briefly, the invention provides a device for imparting rotary motion to a barrel cap comprising means for receiving rotary motion upon a first portion of said device; means for transferring said rotary motion to a second portion of said device; and means for securing said second portion of said device to the barrel cap.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a front elevation view of a device for imparting rotary motion to a barrel cap in accordance with the present invention.

FIG. 2 is a right side elevation view of the device of FIG. 1.

FIG. 3 is a left side elevation view of the device of FIG. 1.

FIG. 4 is a sectional view taken along line 4-4 of FIG. 3.

FIG. 5 is a front elevation view of an alternate device for imparting rotary motion to a barrel cap in accordance with the present invention.

FIG. 6 is a right side elevation view of the device of FIG. 5.

FIG. 7 is a left side elevation view of the device of FIG. 5.

FIG. 8 is a sectional view taken along line 8-8 of FIG. 7.

FIG. 9 is a front elevation view of an alternative device for imparting rotary motion to a barrel cap in accordance with the present invention.

FIG. 10 is a right side elevation view of the device of FIG. 9.

FIG. 11 is a left side elevation view of the device of FIG. 9.

FIG. 12 is a sectional view taken along line 12-12 of FIG. 11.

FIG. 13 is a perspective view of a prior art barrel cap.

FIG. 14 is a perspective view of a prior art barrel cap.

### DETAILED DESCRIPTION OF THE PREFERRED EMBODIMENT

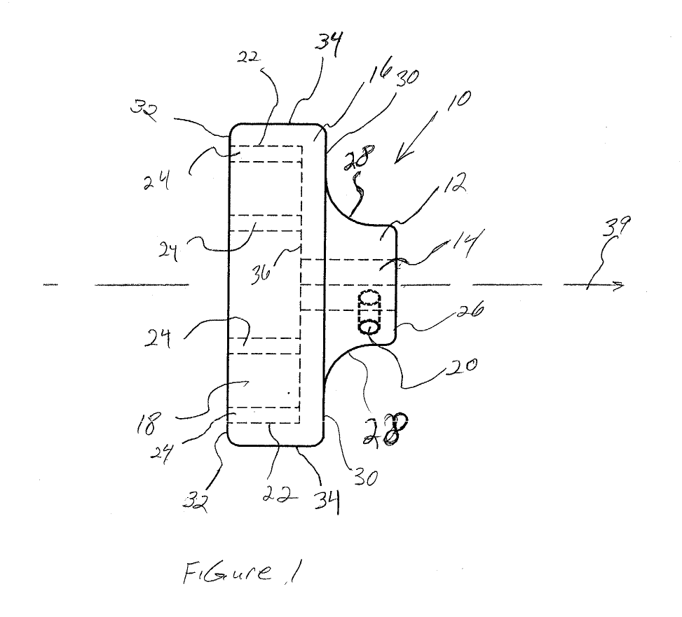

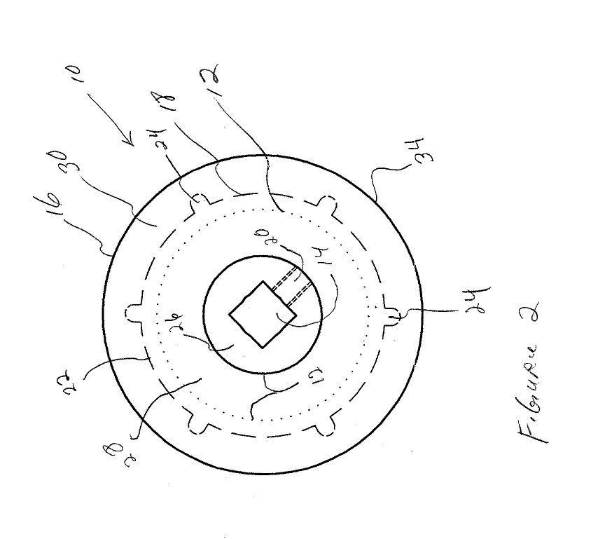

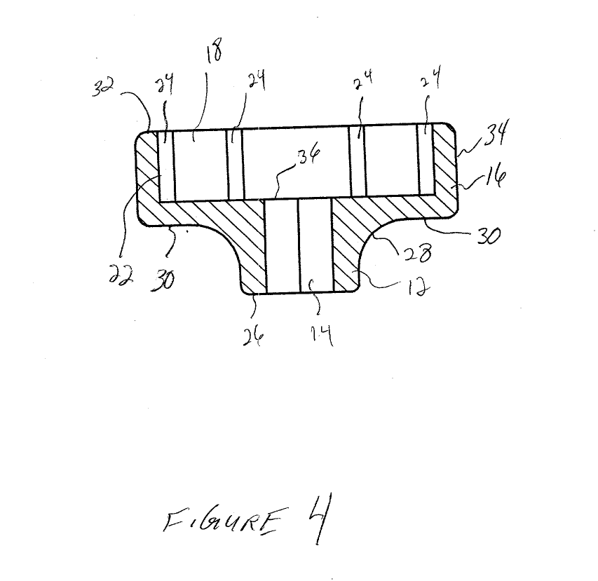

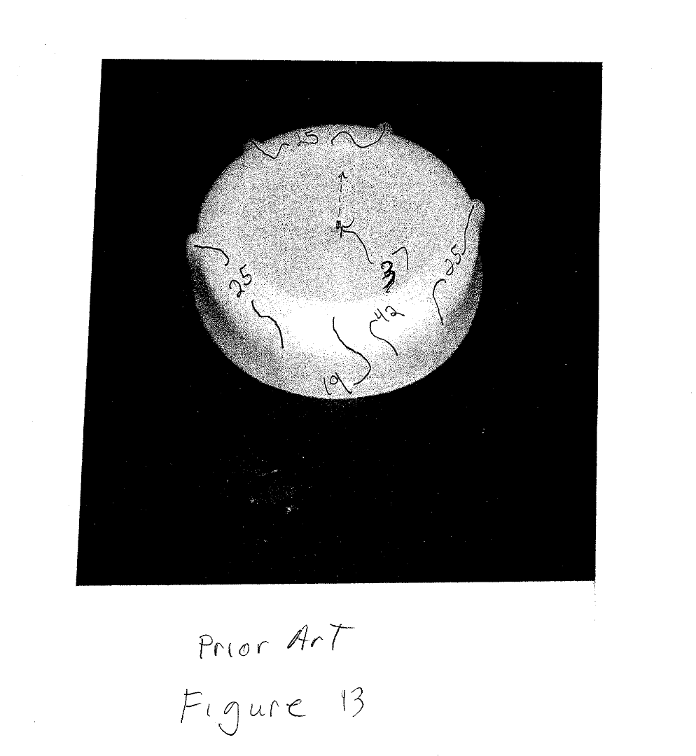

Referring now to the drawings an in particular to FIGS. 1-4, a device for imparting rotary motion to a barrel cap is denoted by numeral 10. The device 10 is fabricated from a single piece of metal, aluminum being the preferred metal, and includes a first portion 12 having a substantially square configured aperture 14 therethrough that extends into a second portion 16 having an annular recess 18 thereby forming an opening that extends through the device 10. The aperture 14 removably receives a shank portion (not shown) of a common, hand held, rotary motion tool that rotates the device 10 to ultimately remove or tighten a barrel cap 19 (FIG. 13) to a standard fifty-five gallon barrel. A set screw aperture 20 is disposed to receive a set screw (not shown) to detachably secure the device 10 to the shank portion of the rotary motion tool such as a standard hand held power tool or ratchet drive. The annular recess 18 includes a cylindrical inner wall 22 having a plurality (six for this device 10 when used with the barrel cap 19 of FIG. 13) of radially displaced drive recesses 24 that are configured and positioned to snugly receive corresponding protuberances 25 of the barrel cap 19 whereby rotary motion is transferred from the device 10 to the barrel cap 19.

The first portion 12 and the aperture 14 therethrough are axially aligned and snugly receive the shank portion at a center portion of an annular, planar, outer wall 26. The first portion 12 includes an arcuate side wall 28 that prevents grease build-up and separates the outer wall 26 from the second portion 16 a distance that promotes the complete longitudinal insertion of the shank portion into the aperture 14 without engaging the barrel cap that is disposed in the annular recess 18. Further, the longitudinal and radial dimensions of the first portion 12 cooperate to provide added mass substantially closer to the axis of rotation of the device 10 to “compensate” for the radially distal and larger mass of the second portion 16, thereby stabilizing the device 10 and reducing “wobble” when the device 10 is rotating to tighten or loosen the barrel cap 19. Without the mass of the first portion 12 to “offset” the relatively larger mass of the second portion 16, which is much more distal to the axis of rotation, the device 10 would have a tendency to wobble to a degree that would damage the threads of the barrel cap 19 and/or the cooperating threads of the cap receiving portion of the barrel.

The second portion 16 and the recess 18 within are axially aligned with the first portion 12 and aperture 14. The second portion 16 is substantially larger than the first portion 12 to accommodate relatively large barrel caps 19. The second portion 16 includes annular, planar, first and second outer end walls 30 and 32 that are separated by an outer cylindrical side wall 34. The end walls 30 and 32, and the side wall 34 are configured to accommodate the recess 18 which is dimensionally defined to snugly receive a corresponding portion of the barrel cap 19. The second portion 16 further includes an annular, planar, inner wall 36 that defines the “depth” of the recess 18 and the metal “thickness” of the second portion 16 between the outer end wall 30 and the inner wall 36.

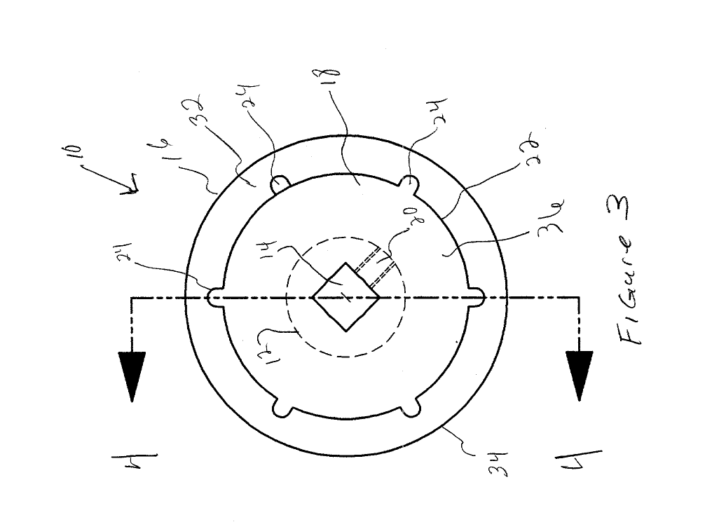

The drive recesses 24 in the inner cylindrical wall 22 correspond to the quantity, configuration and radial displacement of protuberances on an outer wall of the barrel cap 19. One type of barrel cap 19 (see FIG. 13) is fabricated from plastic and has six arcuate protuberances 25 radially separated a constant degree of arc with all protuberances 25 being longitudinally parallel to the central axis 37 of the cap 25. The drive recesses 24 are configured substantially semi-circular, when taking a left side elevation view of the device 10 (see FIG. 3), and are longitudinally parallel to the central axis 39 of the device 10. The longitudinal dimension of the recesses 24 should equal or exceed the longitudinal dimension of the protuberances 25 to prevent the metal device 10 from deforming the plastic protuberances 25 when a relatively large quantity of rotary force is imparted from the device 10 to the barrel cap 19. Should the cap 19 be fabricated from steel, both device 10 and the cap could deform if the longitudinal dimension of the recesses 24 is less than the longitudinal dimension of the protuberances 25.

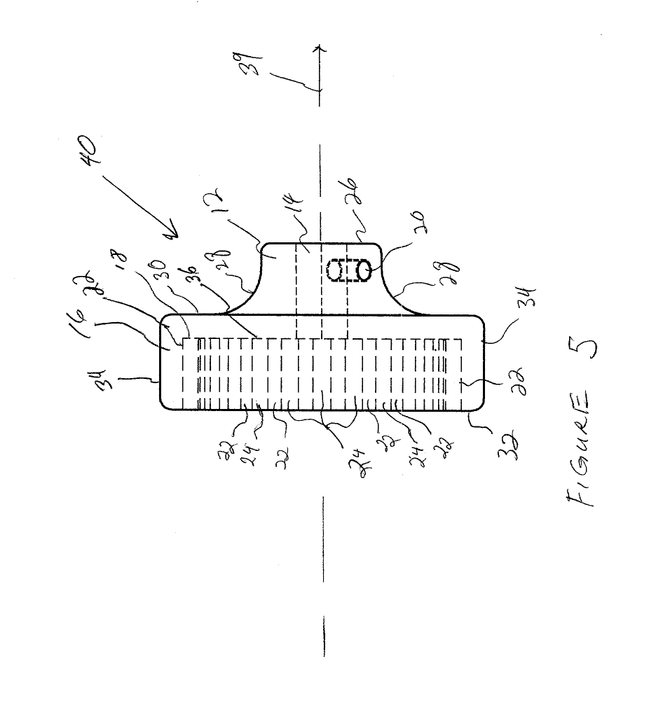

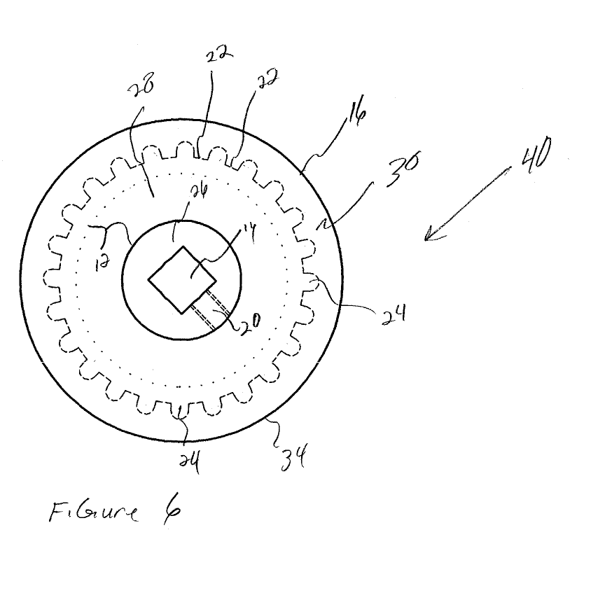

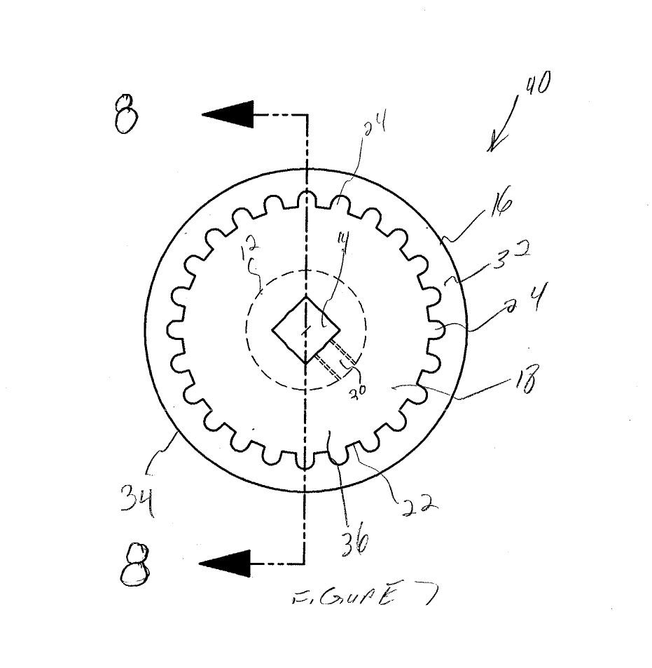

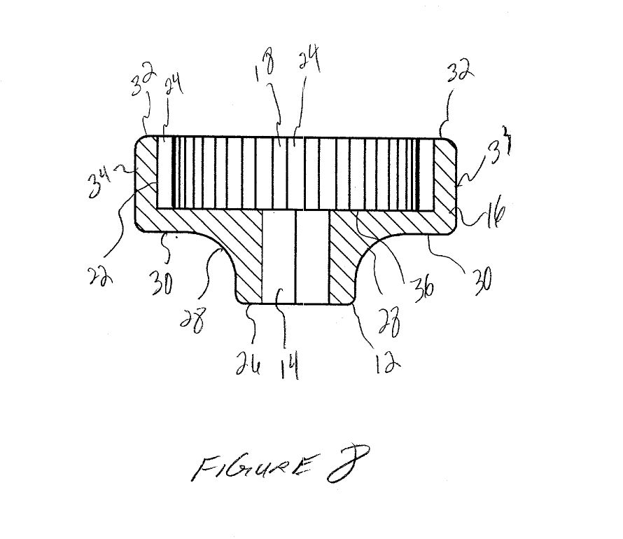

Referring now to FIGS. 5-8, an alternate device for imparting rotary motion to a barrel cap is denoted by numeral 40. The alternate device 40 is substantially identical to the above described device 10 except that the alternate device 40 includes a cylindrical inner wall 22 having twenty-four radially displaced drive recesses 24 that are configured and positioned to snugly receive substantially less protuberances 25 disposed about the cylindrical outer wall 42 of the barrel cap 19, thereby reducing the degree of rotation of the alternate device 40 (compared to the aforementioned device 10) to longitudinally align with and receive the corresponding protuberances 25 of the barrel cap 19. Thus, by increasing the quantity of recesses 24 relative to the protuberances 25, the operator of the alternate device 40 is able to engage the device 40 with the barrel cap 19 faster via reduced radial motion relative to the cap 19 when inserting the cap 19 in the recess 18 of the second portion 16 of the device 40. This small reduction of radial motion results in a large reduction of man hours when removing or installing barrel caps 19 on large quantities of standard barrels. Although twenty-four is the quantity of recesses 24 detailed above, more or less numbers of recesses 24 could be utilized. However, integral multiples of the number of protuberances 25 of the cap 19 should determine the number of recesses 24 in the inner cylindrical wall 22 of the second portion 16 of the alternate device 40.

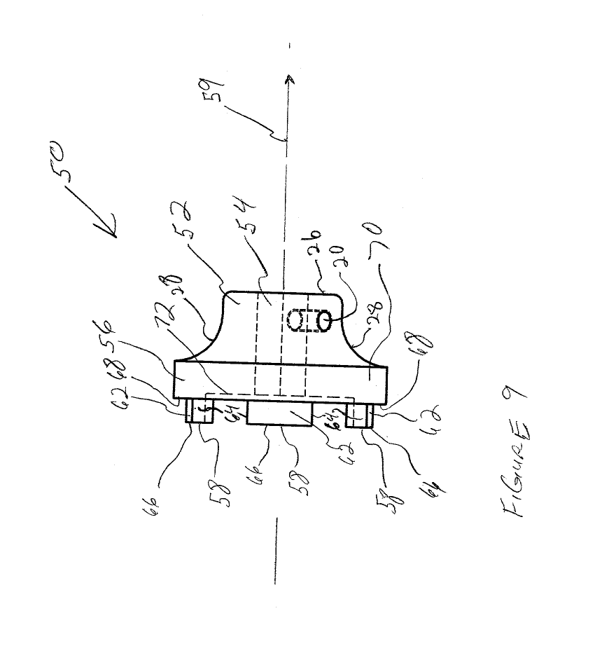

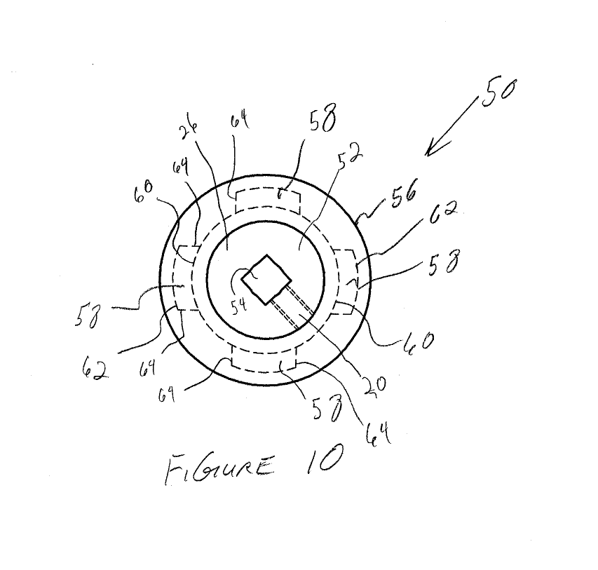

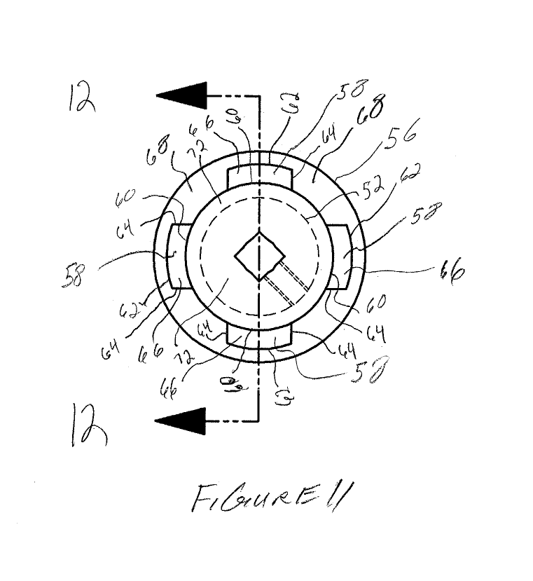

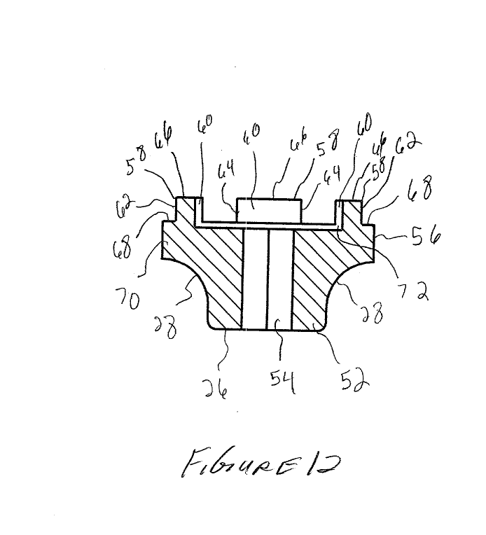

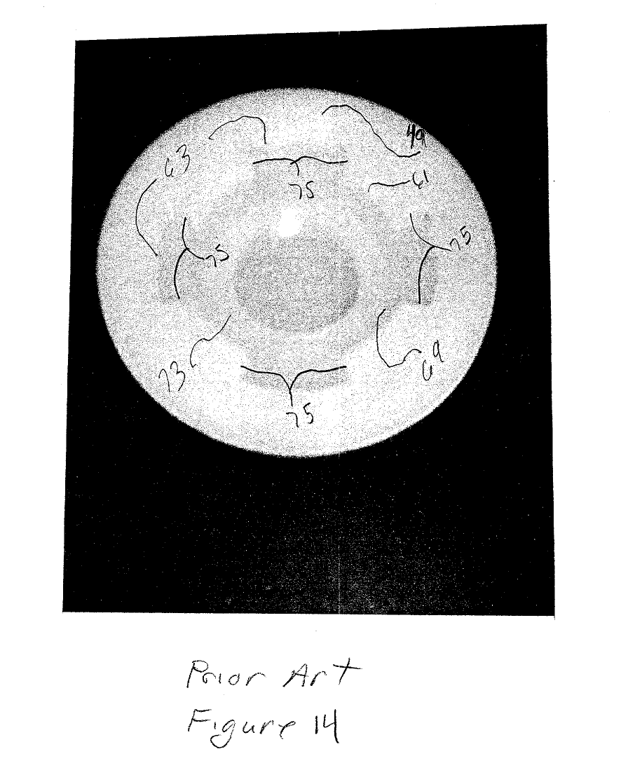

Referring now to FIGS. 9-12, another alternative device for imparting rotary motion to a barrel cap 49 (see FIG. 14) is denoted by numeral 50. The alternative device 50 is relative smaller than the above detailed devices 10 and 40, and includes a substantially identical first portion 52 having the same square configured aperture 54 therethrough that extends into a second portion 56 configured to cooperatively join with a predetermined configuration of a barrel cap 49. The configuration of the second portion 56, when taking a left side view, includes a plurality of oppositely disposed arcuate protuberances 58 having concentric inner and outer arcuate walls 60 and 62. The inner walls 60 are radially displaced about a central axis 59 of the device 50 a predetermined distance that corresponds to a radially displaced first inner wall 61 of the barrel cap 49. The outer walls 62 are radially displaced about the central axis 59 of the device 50 a predetermined distance that corresponds to a radially displaced second inner wall 63 of the barrel cap 49. The arcuate protuberances 58 include planar side walls 64 integrally joined to the inner and outer walls 60 and 62. The side walls 64 are substantially parallel to the central axis 59 of the device 50. The arcuate protuberances 58 further include planar top walls 66 integrally joined to the inner, outer and side walls 60, 62 and 64. The top walls 66 are perpendicular to the central axis 59 of the device 50 and are displaced from a planar bottom wall 68 of the device 50 a predetermined distance that corresponds to the “depth” of a bottom wall 69 of the barrel cap 49. The second portion 56 further includes a relatively large base portion 70 to provide strength and stability to the device 50, and a relatively small recess 72 in the bottom wall 68 to receive therein a corresponding portion 73 of the barrel cap 49 to stabilize the cap 49 while being forcibly rotated by the side walls 64 of the device 50 rotationally engaging cooperating side walls 75 in barrel cap 49.

In operation, a device 10 is selected to impart rotary motion to a correspondingly configured barrel cap 19 that will be secured to or removed from a portion of a standard barrel. An aperture 14 in a first portion 12 of the device 10 removably receives a shank portion of a typical hand held rotary drive tool. Should the operator of the device 10 be required to rotate a large quantity of barrel caps 19, the operator would select a device 40 having more drive recesses 24 than protuberances 25 on the barrel cap 19 to reduce the time required to insert the cap 19 into the second portion 16 of the device 40.

What is claimed and desired to be secured by letters patent of the United States is:

1. A device for imparting rotary motion to a barrel cap comprising:
means for receiving rotary motion upon a first portion of said device;
means for transferring said rotary motion to a second portion of said device; and
means for securing said second portion of said device to the barrel cap.

2. The device of claim 1 wherein said securing means includes configuring said second portion to cooperatively join with a predetermined configuration of the barrel cap.

3. The device of claim 2 wherein said second portion configuration, when taking a left side view, includes a plurality of oppositely disposed arcuate protuberances.

4. The device of claim 3 wherein said arcuate protuberances include concentric inner and outer arcuate walls, said inner walls being radially displaced about a central axis of said device a predetermined distance that corresponds to a radially displaced first inner wall of the barrel cap, said outer wall being radially displaced about said central axis of said device a predetermined distance that corresponds to a radially displaced second inner wall of the barrel cap.

5. The device of claim 4 wherein said arcuate protuberances include planar side walls integrally joined to said inner and outer walls of said arcuate protuberances, said side walls being substantially radially aligned with and parallel to said central axis of said device.

6. The device of claim 5 wherein said arcuate protuberances include planar top walls integrally joined to said inner, outer and side walls of said arcuate protuberances, said top walls of said protuberances being perpendicular to said central axis, said top wall being displaced from a planar bottom wall of said device a predetermined distance that corresponds to the depth of a bottom wall of the barrel cap.

7. The device of claim 1 wherein said first portion is secured to a rotary motion tool.

8. The device of claim 7 wherein said first portion includes an axially aligned recess for removably receiving a shank portion of the rotary motion tool.

9. The device of claim 8 wherein said first portion includes an aperture disposed to receive a set screw to detachably secure said device to the shank portion of the rotary motion tool.

10. The device of claim 2 wherein said second portion configuration, when taking a left side view, includes an annular inner wall axially aligned with and parallel to the central axis of the device.

11. The device of claim 10 wherein said annular inner wall includes a plurality of radially displaced recesses.

12. The device of claim 11 wherein said recesses are configured and positioned to snugly receive corresponding protuberances of a barrel cap whereby rotary motion is transferred from the device to the barrel cap.

13. A socket for imparting rotary motion to a barrel cap comprising:
means for receiving rotary motion;
means for engaging the barrel cap; and
means for stabilizing said engaging means whereby rotary motion is transferred from a rotary device to the barrel cap without causing the barrel cap to wobble.

14. The socket of claim 13 wherein said receiving means includes a recess configured to snugly receive a shank portion of a rotary drive tool.

15. The socket of claim 13 wherein said receiving means includes means for securing a rotary drive tool to a first portion of said socket.

16. The socket of claim 15 wherein said securing means includes a recess disposed to receive a set screw to detachably secure said device to a portion of the rotary drive tool.

17. The socket of claim 13 wherein said engaging means includes an annular inner wall having a plurality of radially displaced recesses configured and positioned to snugly receive corresponding protuberances of the barrel cap whereby rotary motion is transferred from said device to the barrel cap.

18. The socket of claim 13 wherein said stabilizing means includes an elongated drive tool receiving portion axially aligned with said engaging means.

19. The socket of claim 18 wherein said elongated drive tool receiving portion includes an outer end dimension that is substantially smaller than the outer end dimension of said engaging means.

20. A device for removing caps from a barrel comprising:
means for transferring rotary motion from a drive tool to the cap; and
means for removably receiving the cap in a recess portion of said device, said recess portion having means for rotating said cap at a plurality of positions relative to said device.

21. The device of claim 20 wherein said transferring means includes a recess configured to snugly receive a shank portion of the drive tool.

22. The device of claim 20 wherein said transferring means includes stabilizing means.

23. The device of claim 22 wherein said stabilizing means includes an elongated drive tool receiving portion.

24. The device of claim 20 wherein said receiving means includes an annular inner wall.

25. The device of claim 24 wherein said annular inner wall includes a plurality of radially displaced recesses that are configured and positioned to snugly receive corresponding protuberances of the cap.

26. The device of claim 25 wherein radially adjacent recesses are separated a radial distance measuring less than the radial distance separating radially adjacent protuberances of the cap whereby said device is capable of limiting radial motion of the drive tool relative to the cap when inserting the cap in the recess portion of said device.
